(19) United States
(12) Patent Application Publication
(10) Pub. No.: US 2004/0220965 A1
(43) Pub. Date: Nov. 4, 2004

(54) Indexed database structures and methods for searching path-enhanced multimedia

(76) Inventors: Michael Harville, Palo Alto, CA (US); Ramin Samadani, Menlo Park, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/427,647

(22) Filed: Apr. 30, 2003

(51) Int. Cl. G06F 17/00

(52) U.S. Cl. 707/104.1

(57) ABSTRACT

Media from multiple sources is labeled with time and location metadata organized as individual paths and shared in a common searchable database with search tools that take advantage of spatio-temporal relationships between the different paths. This combination of path oriented data and path oriented search tools permits an individual associated with a first path to locate information associated with another spatio-temporally related path. In particular, certain embodiments of the invention can facilitate the use of a given set of path data and/or path-enhanced multimedia to identify other paths and path-enhanced multimedia that overlap or intersect in space and/or time within a specified precision. Path information previously recorded by one user may be used in accordance with the present invention to obtain multimedia recorded on a different path by a different user, but that is close in space and time to a location on the user's own path.

### CROSS-REFERENCE TO RELATED APPLICATIONS

Commonly assigned patent application filed concurrently herewith under attorney docket number 10019923-1, entitled “Apparatus and Method for Recording “Path-Enhanced” Multimedia”, describes a multimedia recording appliance that can record audio, still images or video individually or in combinations, and that is capable of sampling time and position information whether or not it is recording any multimedia (e.g., audio or images), thereby providing a record of multimedia, and path traveled during and between the recording of those sounds and/or images. The recorded data that this appliance generates are examples of “path-enhanced” multimedia, and the identified patent application is hereby incorporated by reference in its entirety.

Other commonly assigned patent applications filed concurrently herewith describe various other contemplated applications for “path-enhanced” multimedia technology, and each of the following identified patent applications is also hereby incorporated by reference in its entirety:

Docket Number 10019924-1 “Systems and Methods of Viewing, Modifying, and Interacting with “Path-Enhanced” Multimedia” relates to a display apparatus and method which uses a path derived from spatial and temporal relationships to explore, enhance and edit a sequence of text, sounds, still images, video and/or other “multimedia” data. Moreover, the data defining any such associated path may also be edited to thereby define a new or modified path.

Docket Number 100200108-1 “Automatic Generation of Presentations from “Path-Enhanced” Multimedia” relates to apparatus and methodology for generating a presentation of multiple recorded events together with an animated path-oriented overview connecting those events.

### FIELD OF THE INVENTION

The present invention relates generally to an indexable data structure that stores path information and associated multimedia data, and more particularly this disclosure describes systems and methods of indexing, modifying, and searching the data structure.

### BACKGROUND

A number of consumer-oriented electronic recording devices are currently available which combine sound, still image and video camera capabilities in an easy-to-use format, in which the captured data is optionally time-stamped with a self-contained clock. Recording devices have also been proposed which use GPS technology to identify the exact time and location that a particular sound or image was recorded. Still and video digital images with attached GPS data from a known recording device may be processed using known web-based systems for generating web-enabled maps overlaid with icons for accessing such digital images.

Web-based databases are available for posting and sharing photographs and other multimedia, possibly identified by time and place.

### BASIC CONCEPTS AND DEFINITIONS

### Multimedia

Although “multimedia” has been variously used in other contexts to refer to data, to a sensory experience, or to the technology used to render the experience from the data, as used herein it broadly refers to any data that can be rendered by a compatible machine into a form that can be experienced by one or more human senses, such as sight, hearing, or smell. Similarly, although “multimedia” has been used elsewhere specifically in connection with the presentation of multiple sensory experiences from multiple data sources, as used herein it is intended to be equally applicable to data representative of but a single sensory experience. Common examples of such multimedia include data originally captured by physical sensors, such as visible or IR images recorded by photographic film or a CCD array, or sounds recorded by a microphone, or a printed publication that has been microfilmed or digitized. Other currently contemplated examples include data that is completely synthesized by a computer, as for example a simulated flight in space, digital text (in ASCII or UNICODE format) that can be rendered either as a page of text or as computer generated speech, or data representative of certain physical properties (such as color, size, shape, location, spatial orientation, velocity, weight, surface texture, density, elasticity, temperature, humidity, or chemical composition) of a real or imaginary object or environment that could be used to synthesize a replica of that object or environment. Multimedia data is typically stored in one or more “multimedia files”, each such file typically being in a defined digital format.

### Location

Location may be defined in terms of coordinates, typically representative of the user's position on the Earth's surface. Many coordinate systems are commonly used in celestial mechanics and there are known transformations between the different coordinate systems. Most coordinate systems of practical interest will be Earth centered, Earth-fixed (ECEF) coordinate systems. In ECEF coordinate systems the origin will be the center of the Earth, and the coordinate system is fixed to the Earth. It is common to model the Earth's shape as an ellipsoid of revolution, in particular an oblate spheroid, with the Earth being larger at the equator than at the poles. The World Geodetic System 1984 (WGS84) is an example of such a coordinate system commonly used in GPS applications. Within the WGS84 system, latitude and longitude will define any location on the Earth's surface. Any other generalized coordinate system, instead of latitude and longitude, defined on the ellipsoid, could be used to reference locations on the Earth. For some applications, a third coordinate, altitude will also be required. In GPS applications, altitude typically measures the distance not above the actual terrain, but above (or below) the aforementioned oblate spheroid representation of the Earth. In other applications, location could be represented in a one-dimensional coordinate system, corresponding for example to mileposts or stations (or even scheduled time) along a predetermined route.

### Time

Similar to location, there are many methods for representing time. In many data processing applications, time is defined as the numerical representation of the time difference between the current time and an absolute reference time using some time scale. Local time may be calculated from this numerical representation by using additional latitude and longitude information.

Coordinated Universal Time (UTC) is a modern time scale that serves as an example of the time scale used in these inventions. The UTC time scale defines a very steady second and it is also tied to the earth's rotation. The second is defined in terms of the duration of a given number of periods of the radiation produced by the atomic transitions between two hyperfine levels of the ground state of cesium-133. In addition, the UTC system is synchronized to drifts in speed of the Earth's rotation by the addition of leap seconds.

### Path

As used herein, “path” means an ordered sequence of locations (from GPS or otherwise; it may include latitude, longitude and/or altitude) each having an associated sequential time stamp (typically from GPS, from other wireless services, and/or from an internal clock or counter). Equivalently, a “path” may be thought of as a sequence of time data, each associated with a respective location from a sequence of locations.

### “Path-Enhanced” Multimedia (PEM)

The association of path information (e.g., time and location data) and multimedia generates “path-enhanced” multimedia. Path information is recorded for the path traveled between and during the recording of the individual recorded multimedia files. In other words, the path information includes path times and locations at which multimedia was and was not recorded. Note that one multimedia file associated with a given point on a path (i.e., a specified point in time and space) can correspond to more than a single instant of time, and that more than one multimedia file can be associated with the same point.

### Brief Summary Of Invention

An indexable database and methods of indexing, searching, and modifying the database are described. The database stores a collection of recorded multimedia and path information, and has a database structure including a linked sequence of path segments. Each segment consists of at least one respective geotemporal anchor. Each geotemporal anchor includes an associated time and at least some of the anchors include an associated location. The anchors collectively define a specified path in space traversed over a specified period in time. At least some of the anchors are linked to respective instances of the recorded multimedia. The database establishes temporal and spatial relationships between the individual multimedia and paths to facilitate searching, modifying, and indexing the database. The invention can facilitate the use of a first given set of path data and/or “path-enhanced” multimedia data to identify a second set of paths, multimedia, and other information associated with these paths and multimedia that have times and/or locations that are near, within a specified precision, those associated with the first set.

### BRIEF DESCRIPTION OF DRAWINGS

FIG. 1 illustrates an exemplary map of San Francisco overlaid with a representation of a path and icons for audio, video, and photos;

FIGS. 2A and 2B are exemplary data structures for “path-enhanced” multimedia and databases, thereof;

FIG. 3 illustrates a simplified example of a tree data structure;

FIG. 4 is a conceptual illustration of dividing a window in a three-dimensional spatio-temporal domain in accordance with an oct-tree structure for indexing data in this spatio-temporal domain;

FIG. 5 is a flowchart illustrating one embodiment of a technique of inserting data into a PEM database;

FIG. 6 is a flowchart illustrating one embodiment of a technique of deleting data from a PEM database;

FIG. 7 is a flowchart illustrating one embodiment of a first, point-oriented search operation according to the present invention;

FIG. 8 is a flowchart illustrating one embodiment of a second, path-oriented search operation according to the present invention;

FIG. 9 shows the input to a chamfer distance calculation algorithm;

FIG. 10 shows the results of applying the chamfer algorithm to the input of FIG. 9;

FIG. 11 is a flowchart illustrating an embodiment of a test process for use in the operation shown in FIG. 8;

FIG. 12 is a flowchart diagram of various exemplary searches and queries.

### DETAILED DESCRIPTION OF EXEMPLARY EMBODIMENTS

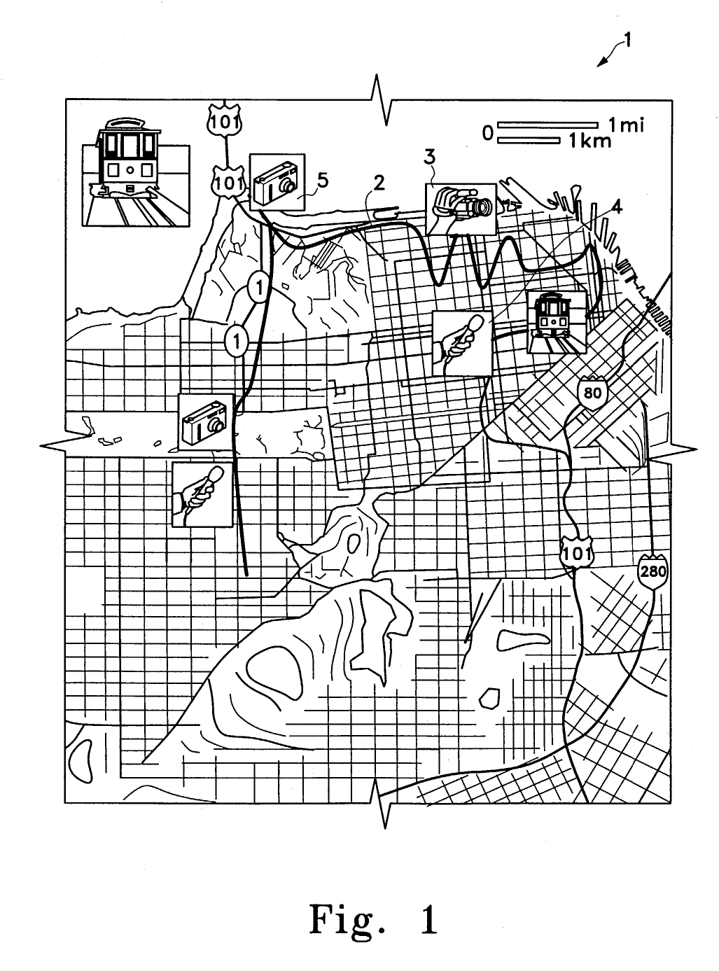

FIG. 1 shows an example of a display of “path-enhanced” multimedia recorded during a tourist's trip to San Francisco (Map 1). In particular, the tourist has followed a path (Path 2) and used a “path-enhanced” multimedia recorder, such as that described in the referenced application entitled “Apparatus and Method for Recording “Path-Enhanced” Multimedia” (Docket no.: 10019923-1), to measure and record that path 2, and to capture various multimedia files (Video 3, Sound 4, Photo 5) while traveling along path 2. As disclosed in the referenced application entitled, “Systems and Methods of Viewing, Modifying, and Interacting with “Path-Enhanced” Multimedia” (Docket no.: 10019924-1) and the referenced application entitled, “Automatic Generation of Presentations from “Path-Enhanced” Multimedia (Docket Number 100200108-1), the recorded information can be used, for example, to reconstruct presentations of the trip experience, to help organize the recorded multimedia by location or time, to compare this trip with previous ones to the same area, and to search for current information about some of the places that were visited. The multimedia captured by a user on a given trip may optionally be labeled or enhanced with information, using either automatic means supplied by the capture device itself, or through manual user input at a later time. In the case of photo and video media, examples of automatic annotation include the camera orientation and inclination (as measured by a compass and inclinometer built into the camera, for instance) and field-of-view (as determined from the camera focal length or zoom setting) at the time the imagery was captured.

According to one embodiment of the present invention, a database includes at least one of the following types of data entries (1) path information (sequences of time and location data (e.g., coordinates)); and (2) multimedia data associated with the path information. The data entries may be captured by one or more individuals that may or may not be associated with or aware of each other. For instance, the database may contain the paths and/or geo-referenced multimedia obtained by many different people on many different trips at many different times.

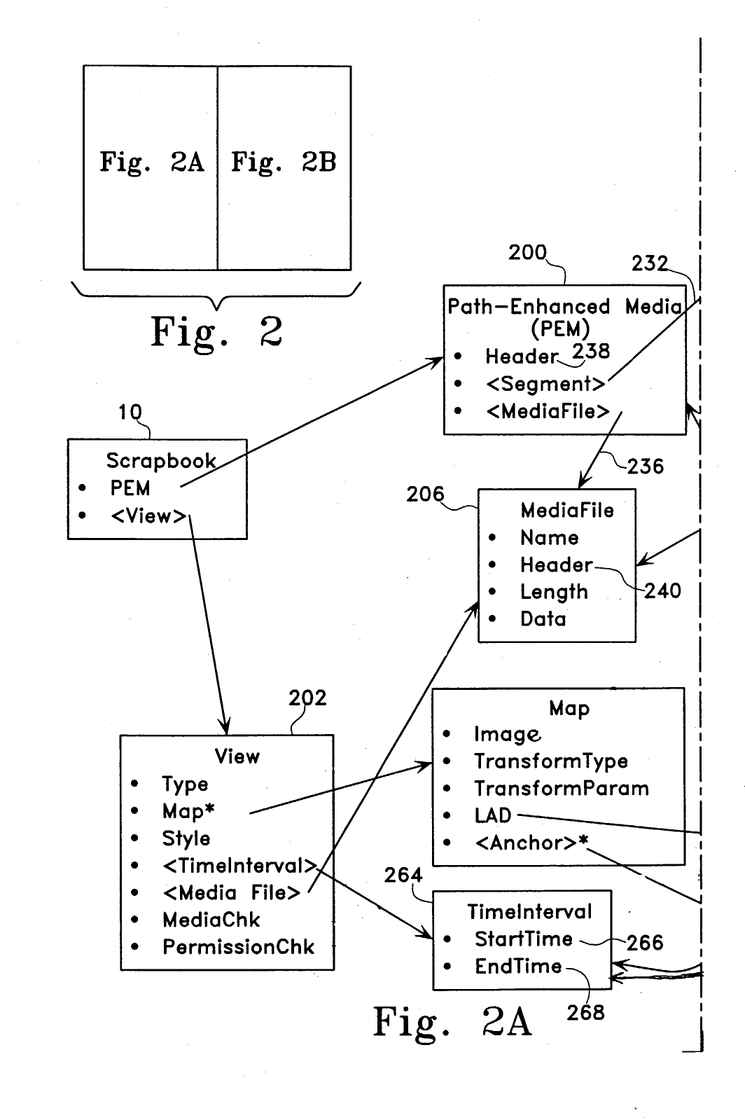

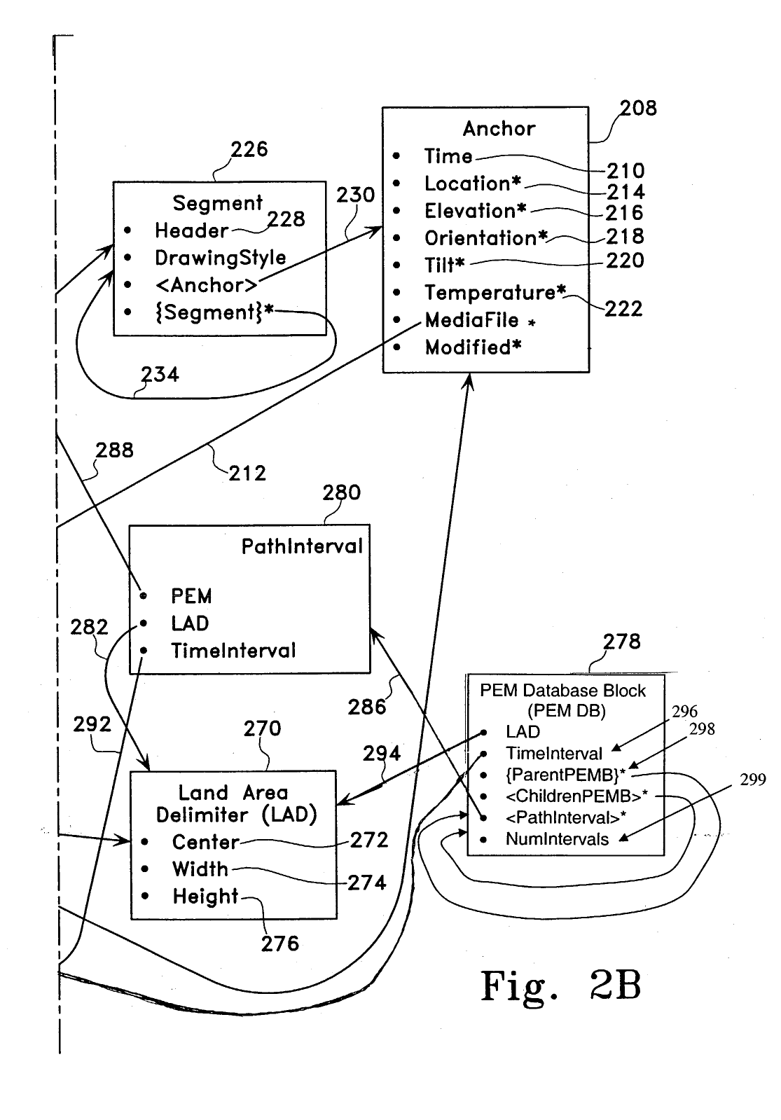

In one embodiment, the database stores a collection of PEM data. FIGS. 2A and 2B show an example of data structures for storing a PEM and databases thereof. These data structures and others described herein are denoted according to the following conventions: paired angle brackets “<>” indicate a possible list of data structures of the indicated type, paired curly brackets “{ }” indicate a recursive data structure, and an asterisk “*” indicates an optional field.

According to the embodiment of FIG. 2, each PEM object 200 includes (indirectly, through its Segment list 232) two basic components: recorded GeoTemporalAnchors 208 (sometimes abbreviated herein as Anchor) and associated MediaFiles 206. Each GeoTemporalAnchor 208 can include not only a Time 210 (i.e., path time data), but also an optional Location 214 (i.e., path location data) if a reliable measurement has been obtained at the associated Time 210. Each GeoTemporalAnchor 208 may also contain fields storing various types of auxiliary sensor data such as Elevation 216, Orientation 218, Tilt 220, and Temperature 222 that are sampled and recorded in an essentially continuous manner similar to Time 210 and Location 214 at the time of recording the PEM. Each GeoTemporalAnchor 208 may also contain a pointer 212 to a particular MediaFile 206, although in alternative embodiments the MediaFile and GeoTemporalAnchor could be combined into a single object (which might exclude use of conventional file formats for the MediaFile 206), or the association could be made by means of a separate link table. Each MediaFile 206 is typically a data file representing an audio stream (for example, in MP3 format), a still image (for example, in JPEG format), or a video stream (for example, in MPEG format). However, other types of multimedia are contemplated.

A single path may be defined by the Segment 226 data structure, which contains an <Anchor> list of pointers 230 to GeoTemporalAnchors 208. The Header 228 within the Segment data structure 226 also allows drawing styles, access restrictions, and other attributes (e.g. “Favorite”, “Tentative”, etc.) to be associated with the path. In one embodiment, the user may associate different attributes with different parts of a path. Accordingly, the Segment data structure 226 can represent only a portion of a complete path, or one of several discrete paths in a combined data set. A sequence of several related Segments 226 (for example, portions of a single path recorded by a particular user) may be connected by a recursive {Segment} pointer 234 within the Segment data structure 226, thereby defining a sequence from one Segment to the next within a complete path. Also, different multiple such Segment sequences (possibly with different authors and/or recorded on different visits to the same place) may be included in the PEM data structure by means of <Segment>list 232.

Since each GeoTemporalAnchor 208 may include a pointer 212 to any associated MediaFile 206, there is an indirect association between the PEM 200 and its MediaFiles 206. However, to facilitate searching the complete set of multimedia files associated with a PEM 200, the PEM data structure may include an explicit list 236 of pointers to MediaFiles associated with GeoTemporalAnchors within the Segments 226 of the PEM.

The hierarchical PEM data structure also facilitates different levels of ownership and access to be associated with the different data elements. For example, different PEMs 200 may be created by different authors, or be owned by different users, or belong to different trips, as reflected in the Header 238 for each PEM 200. Similarly, each Segment 226 of the same PEM 200 could be part of the same trip but belong to a different user, as reflected in the respective Segment Header 228. Also, each MediaFile 206 in a particular PEM 200 could have a different creator as reflected in its associated MediaFile Header 240.

As shown in FIG. 2, a given PEM data structure may be associated with one or more Views 202 via a Scrapbook 10 data structure. A particular View 202 can define not only a particular style of rendering the same PEM data (for example, a map-based, calendar-based, or media-type-based View), but can also restrict the rendering to one or more different temporal or spatial portions of a trip (for example, those within specified geographic boundaries or within one or more intervals in time), and can restrict display of media to some subset of that contained in the PEM (for example, those marked as “favorites”). The View data structure is described in the referenced application entitled “Systems and Methods of Viewing, Modifying, and Interacting with “Path-Enhanced” Multimedia” (Docket no.: 10019924-1).

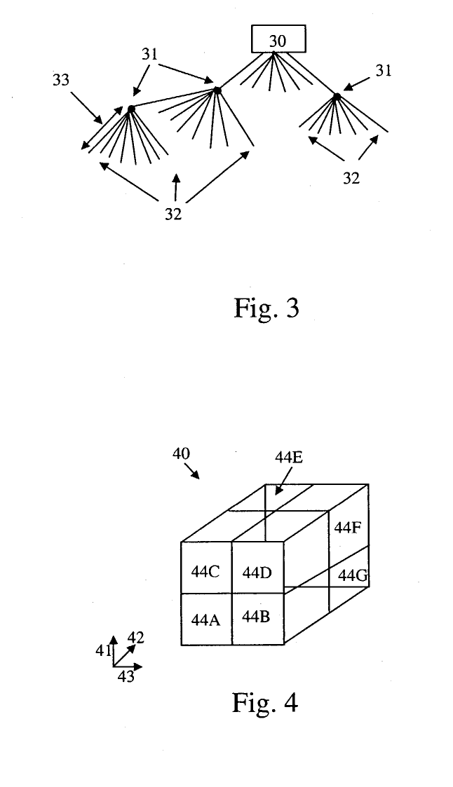

In one embodiment, a collection of PEM data structures, each optionally masked by a View, are stored in a PEM database that is implemented as an indexed tree structure that hierarchically subdivides the collection of PEM data into space and time. FIG. 3 illustrates a simplified example of a tree data structure. As shown, the tree includes a root node 30, and nodes 31, and leaf nodes 32. It is well understood in the field of data structures that the nodes branching out from a given node in a hierarchical tree are typically called the node's “children”, while the original node is referred to as the children's “parent”. In many tree implementations, to facilitate algorithms that traverse the tree structure, each node contains a pointer to its parent as well as a set of pointers to its children. A given node may not be the direct child of more than one parent.

Referring to FIG. 3, in the embodiment of the path-enhanced multimedia database discussed herein, the database is indexed in both space and time via a hierarchical tree, where each node 30, 31 and 32 is implemented with the PEM Database Block (PEMDB) 278 data structure. FIG. 2 shows an embodiment of the PEMDB data structures and related data structures. Each PEMDB 278 node in the hierarchical tree index corresponds to a window in both time and 2D geographical space. The PEMDB 278 representing a given node in the tree therefore stores the bounds of the node's corresponding spatio-temporal window. In one embodiment, the PEMDB 278 stores the bounds using a LandAreaDelimiter (LAD) 270 data structure (pointer 294) to represent the 2D geographical component of the bounds, and using a TimeInterval 266 data structure (pointer 296) to represent the temporal component.

The children of a given node subdivide that node's spatio-temporal window into two or more windows of finer resolution. The PEMDB data structure 278 therefore contains a list of pointers <{ChildrenPEMDB}>* 284 to its children PEMDBs. When this list is empty, the PEMDB 278 is a leaf node.

In the embodiments discussed herein, leaf PEMDBs contain a non-empty list of pointers 286 to portions of PEMs that fall within the spatio-temporal window to which this tree node corresponds. In other words, each leaf of the tree contains a list of pointers to PEM path portions that pass through a particular spatio-temporal window, while each non-leaf of the tree contains pointers to subdividing windows of finer spatio-temporal resolution. The techniques and applications detailed herein may straightforwardly be modified by those skilled in the art to operate on alternative embodiments of the invention, in which a single PEMDB 278 may contain non-empty lists of pointers both to children PEMDBs and to portions of paths passing through its spatio-temporal window.

Each PEM path portion pointed to by a PEMDB leaf is represented by a Pathinterval data structure 280. The Pathinterval data structure contains both a pointer 288 to the particular PEM, as well as a TimeInterval pointer 292 and LAD pointer 282 describing the spatio-temporal bounds of a contiguous portion of this PEM's path that falls within the PEMDB's spatio-temporal bounds. The full list <Pathinterval>* 286 of Pathintervals pointed to by a PEMDB 278 describes all portions 280 of PEM paths in the database that fall within the spatio-temporal bounds of the PEMDB. Note that the Pathinterval list of a single PEMDB may contain multiple Pathinterval entries corresponding to a single PEM—one for each contiguous portion of the PEM's path that falls within the PEMDB's spatio-temporal bounds.

Although in this embodiment the set of Pathintervals pertaining to a single PEMDB is organized as a list, it is envisioned that in other embodiments these Pathintervals may be organized in other ways, for example, to promote greater efficiency of some searches. For instance, the Pathintervals can be organized using a relational database or table structure with key indices based on elements of the Headers of the PEMs to which they point. Alternatively, the Pathintervals can be organized as a tree structure ordered by the geographical bounds of the path portions they select. Furthermore, in some embodiments, the set of Pathintervals for a particular PEMDB may be stored in more than one fashion of organization at any given time, with the appropriate organization being chosen for use according to the type of query or other operation to be conducted on the set. For instance, for queries that concern the owner or capturer of the multimedia data, it may be more efficient to search the Pathintervals when they are organized in a table sorted by their PEM Header values, while for other queries it may be best to search the Pathintervals within a tree structure ordered by the Pathinterval spatial bounds. The same database can store the Pathintervals for each PEMDB in both of these forms, and can use each form for different sets of queries.

In one embodiment, PEMDB data structures contain elements including, but not limited to, the following:

LandAreaDelimiter (LAD) 294: Describes the 2D geographical bounds of the spatio-temporal window with which this block is concerned. In an embodiment that tessellates the globe into sections aligned with the latitudinal and longitudinal direction lines, the LAD can have the following structure:

Center 272: location of the center latitude and longitude of the rectangle.

Width 274: longitudinal extent.

Height 276: latitudinal extent.

TimeInterval 296: Describes the temporal bounds of the spatio-temporal window with which this block is concerned. The TimeInterval contains a StartTime 266 and an EndTime 268.

ParentPEMDB pointer* 298: pointer to parent node of this PEMDB in the tree hierarchy. The parent subsumes a larger spatio-temporal window than does this PEMDB. For the root node of the tree, this parent pointer is set to “null” (no value).

<ChildrenPEMDB>* 284 [list of pointers to “children” PEMDBs, in the next level of PEMDB hierarchy]: Each of these child PEMDBs represents a smaller land area and/or time window subsumed by this block. For the embodiment in which LADs are rectangles aligned with the latitudinal and longitudinal grid, the <PEMDB> list might contain four entries, one for each equal-sized quadrant of this PEMDB's bounds.

<Pathinterval>* 286 [list]: list of portions of PEM paths that pass through the spatio-temporal window corresponding to this PEMDB.

NumIntervals 299: The number of members in the <Pathinterval> list.

As discussed above, the children of a non-leaf PEMDB subdivide the spatio-temporal window of that PEMDB into smaller windows. In one embodiment of the invention, this subdivision occurs in a joint spatio-temporal (three-dimensional) space, such that each child of a given parent node is associated with a spatio-temporal window having spatial and temporal extents that are each smaller than those for the window of the parent. FIG. 4 is a conceptual illustration of a spatio-temporal window corresponding to a PEM database. For example, referring to FIG. 4, the root node (e.g., indicator 30, FIG. 3) at the top of the tree may have a spatio-temporal window 40 encompassing all geographical space and all times with which paths and media in the database are labeled. In one embodiment, the window is defined by three axes 41-43 corresponding to a 1^{st} position indicator (e.g., longitude), a second position indicator (e.g., latitude), and time. If each of the three dimensions of this window is divided in two, and if a new three-dimensional spatio-temporal window is created by selecting one of the two halves in each dimension, then eight different, non-overlapping sub-windows 44A-44H (note window H is not shown) are created. Eight child nodes can be created to correspond to these eight sub-windows, and each node is associated with the data from one quadrant of the full spatial windown and one half of the full time window over which data in the database is distributed. Each of these child nodes might in turn have eight children, each of which is associated with half the time window and a quarter of the spatial extent of its parent. Similar trees are used in many applications that concern searches and other operations in three-dimensional spaces, and these trees are often referred to as “oct-trees”, to reflect the fact that each node is subdivided eight-ways by its children.

In other embodiments of the invention, the root node's spatio-temporal window may be subdivided only spatially, such that each of its children are concerned with the full time window of interest for the database. For example, the root node may have four children, each of which is concerned with data from one quadrant of the geographical space over all time. These nodes, in turn, may again be split only in their spatial extents, and this style of splitting may continue for some number of levels downward in the tree until the spatial resolution of a node is sufficiently fine. At this point, spatial-based splitting is switched to temporal-space splitting, such that the spatio-temporal windows of the children of the node temporally subdivide that of the parent into two or more parts. The temporal dividing points between the children are preferably chosen to balance the number of Pathintervals within each of the child trees of a given node, but any choice of temporal subdivision may be used. Temporal subdivision of a given node's spatio-temporal window may continue over the course of several further, lower layers of the tree, until either the resolution reaches some specified limit, such as an hour or a day, or until the number of Pathintervals in a given node is manageably small. The upper, spatially-subdividing layers of this tree is referred to as a “quad-tree”, (i.e., each node in this portion of the tree has four children), while the lower, temporally-subdividing layers is referred to as a binary tree, (i.e., each node is split into two children).

In still other embodiments of the invention, subdivision of the spatio-temporal windows of the PEMDBs in the tree may occur in a manner similar to that described above, but first by time, and then by space. For example, the initial layers of the tree may subdivide time via a binary tree structure into increasingly fine units, until perhaps the unit of a single day or hour is reached at some level of PEMDB nodes. Then, the nodes beneath these may subdivide geographical space in the quad-tree manner described above, with four children per node.

For all of the styles of spatio-temporal subdivision described above, other numbers of children per node may be used, or different nodes in the same tree may have different numbers of children, without significantly affecting the methods or structure of the invention. Also, other methods of choosing the subdivision boundaries between children may be used without significantly affecting the algorithms described herein. For example, in one embodiment, a dividing point along each dimension is chosen that will either separate the distribution of data along each dimension in half, or that will separate the distribution of data in the 3D spatio-temporal domain into groups of roughly equal size. Any of a number of standard methods, known to those skilled in the art, may be used to measure the distributions of data along a given dimension or in the 3D spatio-temporal domain. In some embodiments, in the case in which a node has no associated data, it is not divided. Furthermore, not all nodes at a given level in the tree are necessarily split, and splitting may be done in a data dependent way (e.g., for nodes which the quantity of the data in their child trees are high).

In some embodiments of the invention, it may be useful to extend the tree index to consider other types of path-enhanced multimedia data, such as elevation, camera orientation, author or capturer of the data, and so forth. Each of these types of data might be used to extend the windows with which the hierarchical tree index nodes are concerned to higher dimensionality. For example, elevation or author name might be added as a fourth dimension to the node windows, or both might be added to make it a window in a five-dimensional space. All of the algorithms and data structures described herein may be straightforwardly modified by those skilled in the art to accommodate changes in the types of data keys over which the hierarchical tree is indexed.

In some embodiments of the invention, it may be useful to index the Pathintervals in the database simultaneously with more than one form of hierarchical tree structure. Then, for a given type of query or other operation, the index with which that operation may be performed most efficiently is selected for use. For example, an embodiment of the invention might contain one tree of PEMDBs that subdivides the spatio-temporal domain first by space and then by time, and a second tree that subdivides the spatio-temporal domain first by time and then by space. For queries that involve a very limited window of space but a large window in time, the former tree would be selected for use, while the latter would be applied for queries that concern a limited window of time but a broad window in space.

Exemplary Methods for Building and Modifying Hierarchical Tree Indices

Hierarchical tree indices such as those described above are used in an exemplary embodiment for indexing a database of “path-enhanced” multimedia data. In these particular embodiments, it may be assumed that the input to these algorithms may be a PEM data structure, or a PEM data structure combined with a View that acts as a mask on the PEM, restricting the portion of it to be used in modifying the database. For related embodiments of the invention, it should be clear to those skilled in the art how to modify the algorithms described below to accommodate other, related forms of input. It should be noted that in the embodiments described herein, it is assumed that the hierarchical tree subdivides time and 2D-space in a joint spatio-temporal way, using an oct-tree structure as described above. It is also assumed that the tree structure contains not just pointers from parents to children, but also pointers from children to parents. The doubly-linked data structure enables efficient tree traversal. FIG. 3 shows an example of a doubly-linked oct-tree data structure. Although only one double-link 33 is shown, it should be understood that other nodes can also be double-linked. For the other tree structure embodiments discussed above, or for related embodiments of the invention, it should be clear to those skilled in the art how to modify the algorithms described below to accommodate appropriate modifications to the described oct-tree data structure.

1: Insertion of a PEM into the Database

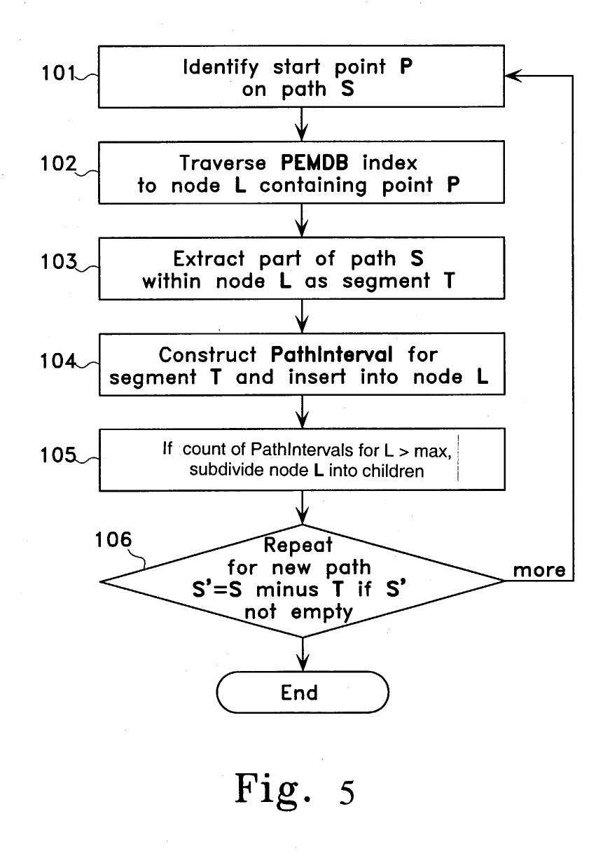

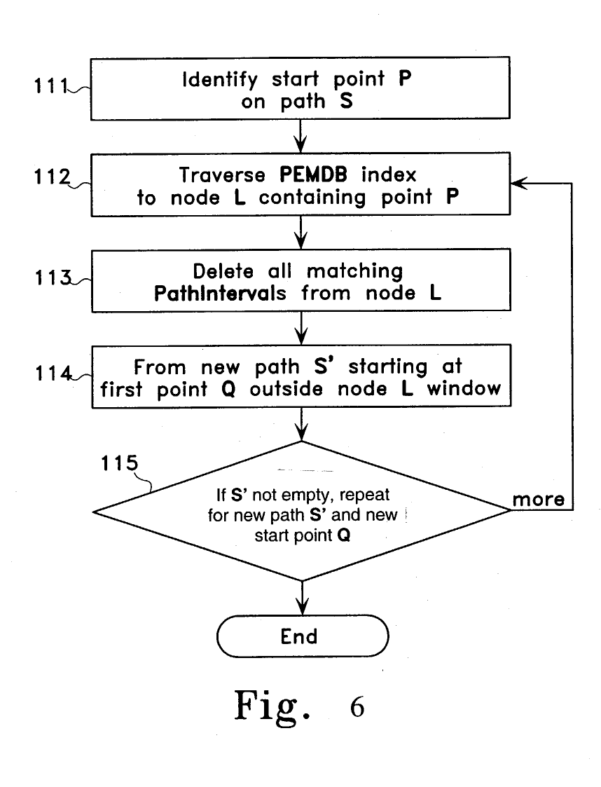

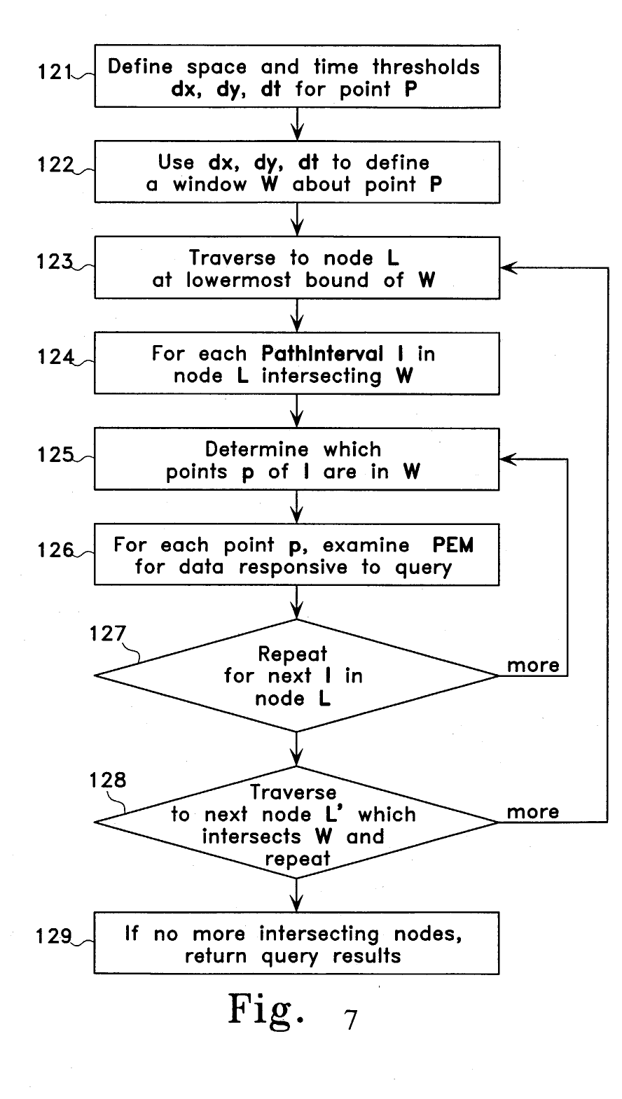

In general, for insertion of a new PEM into an existing database that is structured as an oct-tree, the list of GeoTemporalAnchors in the PEM is traversed, the list is cut into Pathintervals according to where the path crosses the spatio-temporal window boundaries of leaf PEMDB nodes in the tree, and these Pathintervals are inserted into the appropriate PEMDB nodes. In one embodiment, if insertion of a Pathinterval into a given PEMDB node causes the number of Pathintervals for that node to exceed some maximum acceptable number, the node is subdivided into children with smaller spatio-temporal windows so that each child will have a number of Pathintervals that is below the acceptable maximum. In the algorithm description below, and in other techniques described herein, GeoTemporalAnchors are also referred to as “points” (in space and time), for simplicity. One embodiment of the insertion algorithm proceeds as follows, and is further illustrated in FIG. 5:

1. (Block 101) Select the first point P of the path S of the PEM to be inserted. (It should be noted that a PEM comprises a list of Segments, each of which contains a list of GeoTemporalAnchors. Each GeoTemporalAnchor represents a point in space and time, and is optionally associated with other information and pointers to multimedia).

2. (Block 102) Traverse down the PEMDB tree index, starting from the root node, until the leaf node L having spatio-temporal bounds containing the point P is reached.

3. (Block 103) Find the portion of the PEM path S, starting with P, that lies within the spatio-temporal window of L. This can be done by moving forward in time along the path S, starting at P, until a point Q lying outside the spatio-temporal window of L is reached. Add all points from P up to, but not including, Q to a temporary path segment T.

4. (Block 104) Form a PathInterval structure from the temporary path segment T, and insert it into the Pathinterval list of node L.

5. (Block 105) If node L now contains more Pathintervals than some maximum threshold, and if any of these Pathintervals corresponds to a path segment with more than one point in it, subdivide node L into children by the following process:

a. Each dimension of the spatio-temporal extent of node L is split into two parts, thereby forming eight partitions in the 3D spatio-temporal domain. A child node of L is created for each of these eight partitions.

b. For each Pathinterval in the list of node L (including the new one just inserted), insert the Pathinterval into the PathInterval lists of the new child nodes, using the same method as in blocks 101-1 05 above. The Pathintervals are split as needed where they cross the spatio-temporal boundaries of the children.

6. (Block 106) Remove segment T from the PEM path S to form a new path S′ including any remaining points in the path, and (Block 101) select the new first point P′ (=Q) on this path. If there are no more points, the algorithm ends successfully.

7. (Block 102) Traverse up the PEMDB tree from the leaf node L towards the root until a node whose spatio-temporal bounds contain the new P′ is reached, and then traverse down from this node to a new leaf node L′ that contains point P′.

8. (Block 103) Continue as before with this new node L′ and the shorter path point list S′ that starts with point P′.

In the case in which it is desired to add a particular View of a PEM to the database, blocks 101 and 103 the above technique are modified to consider only those portions of the PEM path, and their associated data, that are visible in this View. Only contiguous portions of path visible in the View are used to form Pathintervals (i.e. Pathintervals do not bridge path gaps created by the View mask).

Deletion of a PEM from the Database

A user can remove from the database a PEM that had previously been added according to the method shown in FIG. 5. This may be accomplished as shown in FIG. 6:

1. (Block 111) Select the first point P in the path S of the PEM to be deleted.

2. (Block 112) Traverse the PEMDB tree, starting from the root node, until the leaf node L containing the point P is reached.

3. (Block 113) Search the Pathinterval list of node L for Pathintervals whose PEM pointer matches that of the PEM to be deleted, and remove these matching Pathintervals from the list.

4. (Block 114) Move forward in time along the PEM path S until the first point Q that is outside the spatio-temporal window of L is reached, or until the end of S is reached. If the end of S is reached, the algorithm ends successfully; otherwise, (Block 115) replace the PEM path S with the list of points in the path from Q to the end, and select the new first point on this list, which is Q.

5. (Block 112) Traverse up the PEMDB tree from the leaf node L towards the root until a node whose spatio-temporal bounds contain the Q is reached, and then traverse down from this node to a new leaf node L′ that contains point Q.

6. (Block 113) Return to block 113 and continue as before, using the leaf node L=L′ and the new start point P=Q.

In the case in which it is desired to remove a View of the PEM that differs from the View used when the PEM was added, the above deletion technique is modified to remove only those portions of the PEM path, and the associated data, that are visible in both of the Views in question.

Modification of a PEM in the Database

In one embodiment, the database may be updated/modified to reflect edits to a PEM or a newly selected View. One implementation of an update/modification technique according to the present invention proceeds in a manner similar to the insertion technique (FIG. 5), except that the insertion technique (blocks 104-105) are replaced by comparing the Pathinterval stored in the database with that of the newly modified PEM, and updating the Pathinterval as needed. Alternatively, the deletion technique (FIG. 6) may be used to remove the old PEM from the database, and then the insertion technique (FIG. 5) may be used to add the modified PEM to the database.

Operations on Path-enhanced Multimedia Databases

A variety of queries may be formed for searching the PEM database. According to the present invention, first and second search operations may be used as components in implementing these queries on the PEM database. These two search operations are 1) searching for data that is near a particular point in time and space, and 2) searching for data near a particular portion of a path. According to these operations, it can be assumed that the hierarchical tree subdivides time and 2D-space in a joint spatio-temporal way, using an oct-tree structure and that the tree structure contains pointers from parents to children and from children to parents, to promote efficient tree traversal. For the other tree structure embodiments discussed herein, for related choices of data structures, and for related embodiments of the invention, it should be clear to those skilled in the art how to modify the searching operations and methods described below to accommodate any differences in data structures. Moreover, the following description assumes one temporal dimension t and two spatial x and y-dimensions, but these dimensions may generally denote any coordinate system for time and 2D location.

Search for Data Near a Space-time Point

The first search operation (also referred to as a point-oriented search operation) is illustrated in FIG. 7, and searches the database for PEMs that pass near a particular point, or GeoTemporalAnchor, in time and space. This query point might be selected from some path of interest to the user, such as a point that is currently being browsed or a point that is derived from other sources, including manual specification of time and space coordinates by the user. The search operation can be used to extract data of interest, such as path data, multimedia, or PEM header fields such as the name of the data capturer, from the PEMs that are found to pass near the point.

In general, according to the first search operation, a bounding region of interest is defined around the specified point in space and time, and then the tree index is traversed through all leaf nodes having bounds that intersect this region. Pathintervals of the traversed leaf nodes are inspected for proximity to the point of interest, and those PathInterval found to be near the point are examined for the data of interest. Since each Pathinterval contains a pointer back to the complete PEM from which it was extracted, any type of data associated with path-enhanced multimedia may be searched for via this search operation. In one embodiment, the first search operation is implemented as follows (see also FIG. 7):

1. (Block 121) Let P=[px, py, pt] denote the (three-dimensional) point of interest in space and time, and let dx, dy, and dt denote distance thresholds—two spatial and one temporal, respectively—defining how near some point on a PEM must be in order for that PEM to be selected as being “near” to P. Hence, an intermediate goal of this technique is to select all Pathintervals in the database that contain at least one point having two spatial components and one temporal component that are within dx, dy, and dt of the corresponding components of P, respectively.

2. (Block 122) The spatio-temporal window of interest about P is a 3-dimensional rectangular parallelepiped with sides aligned with the px-dx, px+dx, py−dy, py+dy, pz−dz, and pz+dz planes. This window of interest is denoted as W. The two window corners (P+[−dx,−dy,−dt]) and (P+[dx,dy,dt]) define the lowermost and uppermost spatio-temporal bounds of W, respectively.

3. (Block 123) Beginning at the root node of the oct-tree index, traverse the tree down to the leaf PEMDB node containing the lowermost bound (P+[−dx,−dy,−dt]) of W.

4. (Block 124) For each Pathinterval I in that node's list, check (Block 125) if the spatio-temporal bounds of the Pathinterval (as stored in its LAD and TimeInterval) intersect W. Specifically, all components of the upper spatio-temporal bound of the Pathinterval must exceed the respective components of (P+[−dx,−dy,−dt]), while all components of the lower spatio-temporal bound of the PathInterval must not exceed the respective components of (P+[dx,dy,dt]).

5. If a particular Pathinterval's bounds intersect W, then (Block 126) retrieve the portion of the PEM path indicated by the Pathinterval, and examine the points on the PathInterval to determine which, if any, of these points are in W. In particular, if a point in the PathInterval is found to be in W, the PEM to which it refers is examined for the type of data requested by the query. This data is added to the list of query results being compiled. Some examples of the types of data that might be extracted in this step, and the methods used to extract them, include:

a. If the query is for multimedia data, then each point in the Pathinterval that is found to be in W is additionally checked for a pointer to multimedia data. For continuous media such as video and audio, prior points in time along the path are examined, in case an audio or video recording was initiated at an earlier time and is still in progress at the current point. Any multimedia recording that was either initiated or in progress at the current path point is added to a list of query results. If the query restricts the results by multimedia type, author identity, or other attributes, the list of query results is further refined through examination of other PEM or multimedia file data fields.

b. If the query is for other types of data that may be associated with path points, such as temperature or elevation, then each point in the Pathinterval that is found to be in W is additionally checked for data of the requested type. Any such data found is added to the query result list. In some cases, it may be desired to obtain the average value of all the query results. For instance, an estimate of the temperature at a point in time and space may be obtained by defining a relatively narrow bound W around this point, and then finding the average temperature associated with all path points in the database that are within W.

c. If the query is for the identities of people who traveled along paths near the point of interest, then for each Pathinterval in W, the PEM pointed to by the Pathinterval is retrieved, and the author/capturer attribute is extracted from the PEM Header, provided that privacy restrictions do not preclude this.

d. If the query is for PEMs that passed near the point of interest, to allow, for example, display and browsing by the user via the methods described in the co-pending patent application “Systems and Methods of Viewing, Modifying, and Interacting with “Path-Enhanced” Multimedia”, then the PEM pointed to by the Pathinterval is added to the list of query results if it is not already on the list.

6. After examining all Pathintervals in this leaf PEMDB node (Blocks 125, 126 and 127), traverse (Block 128) the tree to the next PEMDB node having bounds that intersect W. This can be done with standard tree traversal techniques, without any need to return to the root node of the tree to start a new search for nodes within W. Specifically, the traversal proceeds by following the pointer to the current node's parent, and then examining the bounds of each sibling of the current node. For each sibling whose spatio-temporal bounds intersect W, the sub-tree beneath that child is examined recursively. Once all children of the parent node have been explored, exploration moves up to the parent's parent, and a similar process is repeated on that parent's children (excluding those already visited). The portion of the tree this traversal must touch may be cut back if the eight children of each non-leaf node in the oct-tree are always ordered by their bounds in the same way with respect to each other. For example, the children might always be ordered first by the x-components of their bounds, then by their y-components, and then by their t-components. In this case, since the traversal is attempting to proceed from the lowermost bound of W to the uppermost bound, there is no need to check sibling nodes that appear before the current child node in a parent's list.

7. If a new PEMDB leaf node with bounds intersecting W is found, return to Block 123. However, if the traversal reaches a node having bounds that are entirely above the upper bound (P+[dx,dy,dt]) of W, then the traversal ends (Block 129) and the full list of query results is returned.

### Search for Data Near a Portion of a Path

The second, path-oriented search operation performed on the PEM database searches the database for PEMs that pass near any of the points (or, using our data structure terminology, GeoTemporalAnchors) in some contiguous portion of a path. This query path portion might be selected from some path of interest to a user, such as a path that is being browsed via methods like those described in the co-pending applications, but the path portion may also be derived from other sources, including manual specification of time and space coordinates by the user. The second search operation as described below also describes how to extract data of interest, such as path data, multimedia, or PEM header fields like the name of the data capturer, from the PEMs that are found to be near the path portion.

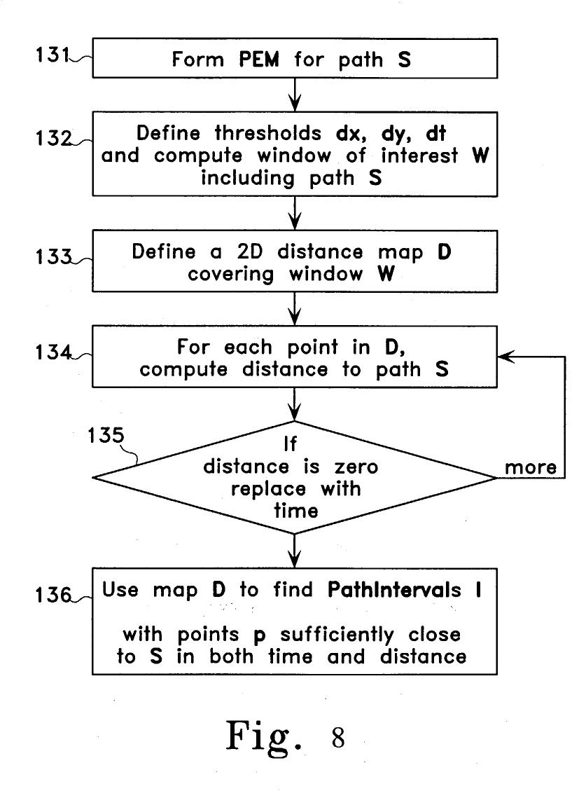

In general, the second search operation forms a 2D map that stores, at each discretely sampled location, the distance from that location to the nearest point on the query path portion. The map is also modified to store, along the locations of the query path portion itself, temporal information for the points on the query path portion. Next, the previously described point-oriented searching technique may be used to retrieve all of the Pathintervals within a bounding box of interest. For each GeoTemporalAnchor (or “point”) belonging to are the path portions indicated by the retrieved Pathintervals, a spatial constraint is checked via the discrete distance map (calculated earlier), and if this test is passed, a temporal constraintis checked. The discrete distance map approach avoids expensive repetitive distance calculations, at the cost of extra storage. Finally, the data of interest is extracted from those path points, or the PEMs to which they belong, that were found to be close to the query path portion. This path-oriented, second search operation can be implemented as follows (see also FIG. 8):

1. (Block 131) Let S denote the path portion for which proximal data is being searched. Form a temporary PEM data structure from the path portion for which proximal data is being searched.

2. (Block 132) Let dx, dy, and dt denote distance thresholds—two spatial and one temporal, respectively—defining how near some point on a second PEM must be in order for that PEM to be selected as “near” to S. Compute a window of interest W by first determining the spatio-temporal bounds of S, and then expanding these bounds by dx on each side in the x-dimension, dy on each side in the y-dimension, and dt on each side in the t-dimension.

3. (Block 133) Allocate a discrete 2D map D that uses [x,y] coordinates and that covers the entire spatial extent of the window W of interest. The resolution of the map may be fixed, or set by user preferences, or computed based on computational resources and/or the spatial extent of S.

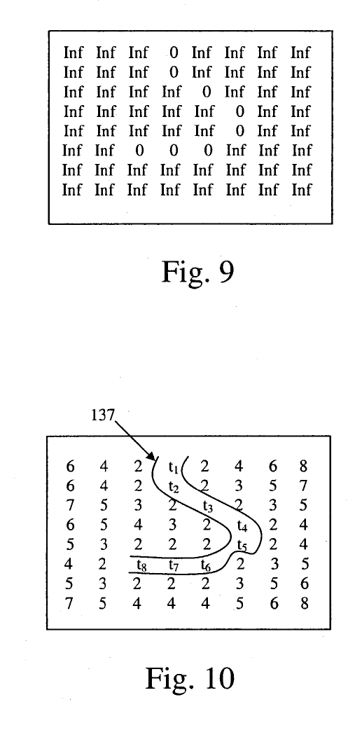

4. (Block 135) For each discrete location in D, compute and store the Euclidean distance to the nearest point in the query path portion S. A chamfer distance transform algorithm may be used to compute approximate Euclidean distance values efficiently. In brief, the chamfer distance transformation assigns a distance of zero to map locations on the path portion S, and then computes the distances to other path locations by incrementing distances from neighbor locations having distance values that are already known. FIG. 9 shows the input to a chamfer distance calculation algorithm. The grid points labeled with zeros are on the path, and the grid points labeled with “Inf”, representing infinity, or the largest distance possible, are off the path. FIG. 10 shows the results of applying the chamfer algorithm to the input of FIG. 9. In FIG. 10, the grid points having numbers show values that are about twice the Euclidean distance to the path. A description of one implementation of a chamfer distance transformation may be found in H. G. Barrow, J. M. Tenenbaum, R. C. Bolles, and H. C. Wolf, “Parametric correspondence and chamfer matching: two techniques for image matching.”, In Proc. 5th International Joint Conference on Artificial Intelligence, pages 659-663, 1977.

5. (Block 135) For locations in D that are on the path S, and therefore store a distance of zero, the zero distance is replaced with a representation of the time for that path location. The representation of the time is such that will not be confused with a distance (for instance, using a negative value instead of a positive one). Hence, in the map D, each location contains either the distance to S, or the time associated with a path location on S. The time labels in FIG. 10 show that a path 137 starts at the top center of the grid, forms a turning loop that ends in the lower center, pointing to the left of the grid.

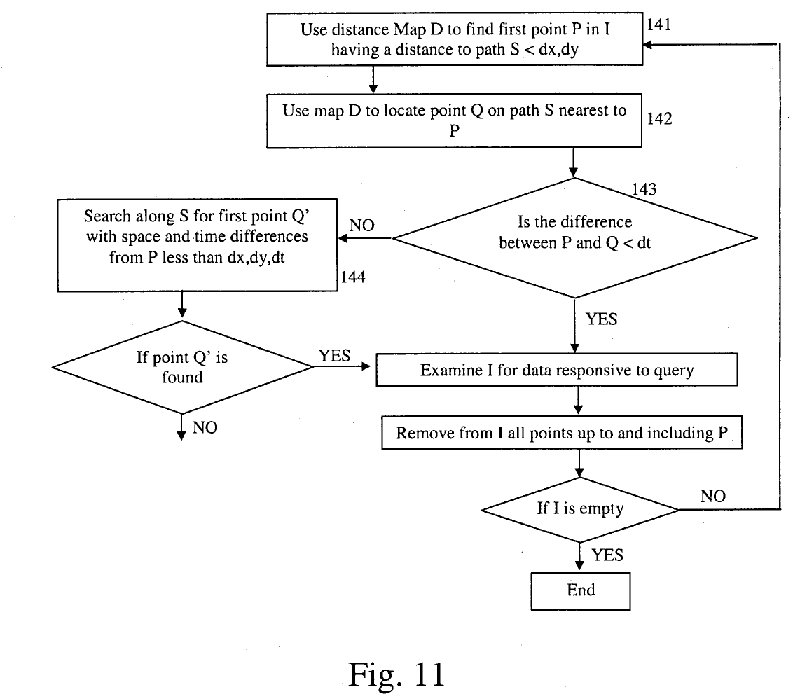

6. Use a modified point-oriented search for Pathintervals near S. Specifically, for each Pathinterval I found to be inthe bounding box W computed in block 132 above, conduct the following steps (see also FIG. 11):

a. (Block 141) Step through the points of Pathinterval I, using the distance map D to determine whether each point is sufficiently close to S. Specifically, for a given path point P, compare the distance value at the location in D in which P falls to the distance threshold determined from dx and dy. If the distance value is below threshold, proceed to block 142; otherwise, repeat block 141 with the next point in the Pathinterval I, if there are any.

b. (Block 142) If a path point P is within the spatial bounds, use the distance map D to move to the point Q on the path portion S that is nearest to P. This can be done by following the distance map gradient downward toward zero, or it can be done more efficiently if, during the process of building D, a pointer to the nearest point on S is also stored at each distance map pixel.

c. (Block 143) Compute the time difference between P and the map value stored at Q, and compare this to the temporal bound dt. If this test is passed, this Pathinterval I is examined for the requested data as performed, for example, in block 126 of the first, point-oriented search operation.

d. Otherwise, (Block 144) search for other points along S that are within acceptable spatio-temporal bounds from P. This is done by tracing back along the path S in the direction that decreases the time difference from P, while incrementing the spatial distance difference originally computed between P and Q to account for this spatial movement along the path. If and when a point along S is reached such that the temporal difference from S is below dt, then check that the spatial difference is still below the acceptable threshold. If so, this Pathinterval I is examined for the requested data as performed, for example, in block 126 of the first, point-oriented search operation. If a point along S is reached such that the temporal difference exceeds dt, then traversal ends and the process returns to block 141, examining the next point in the Pathinterval I.

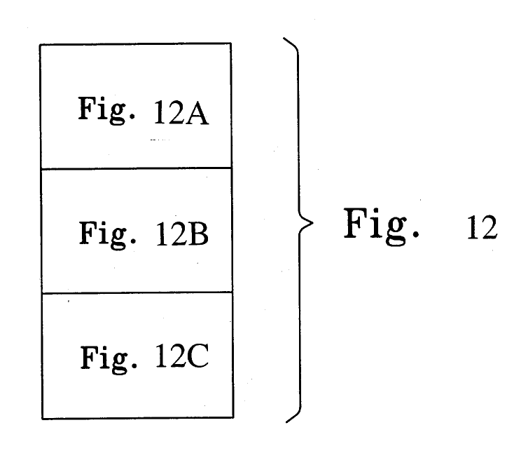

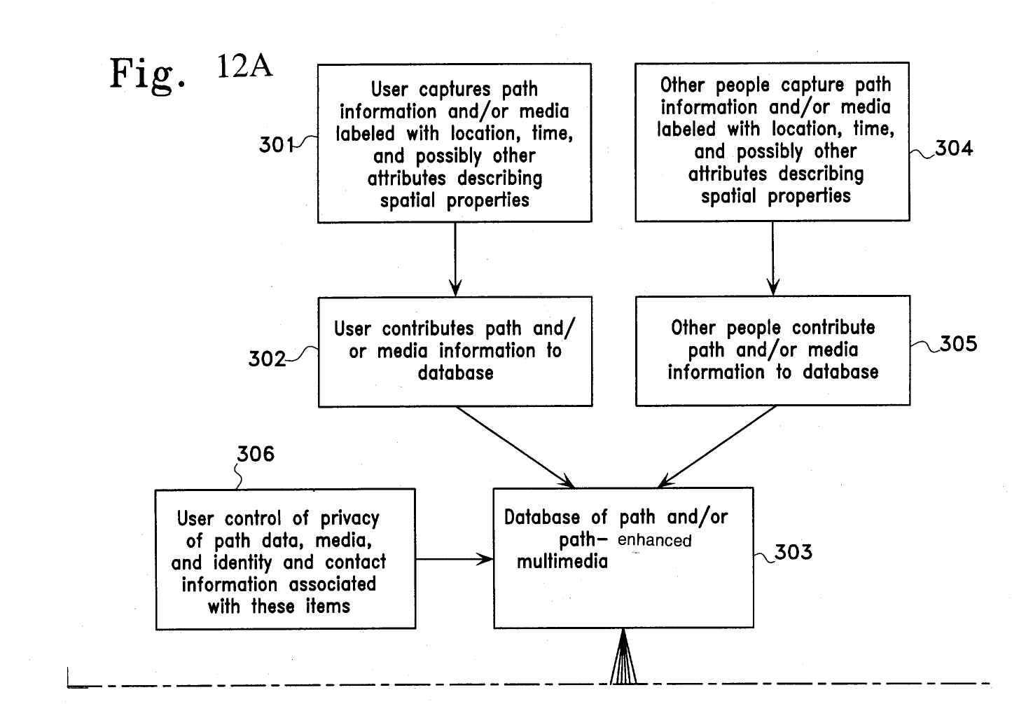

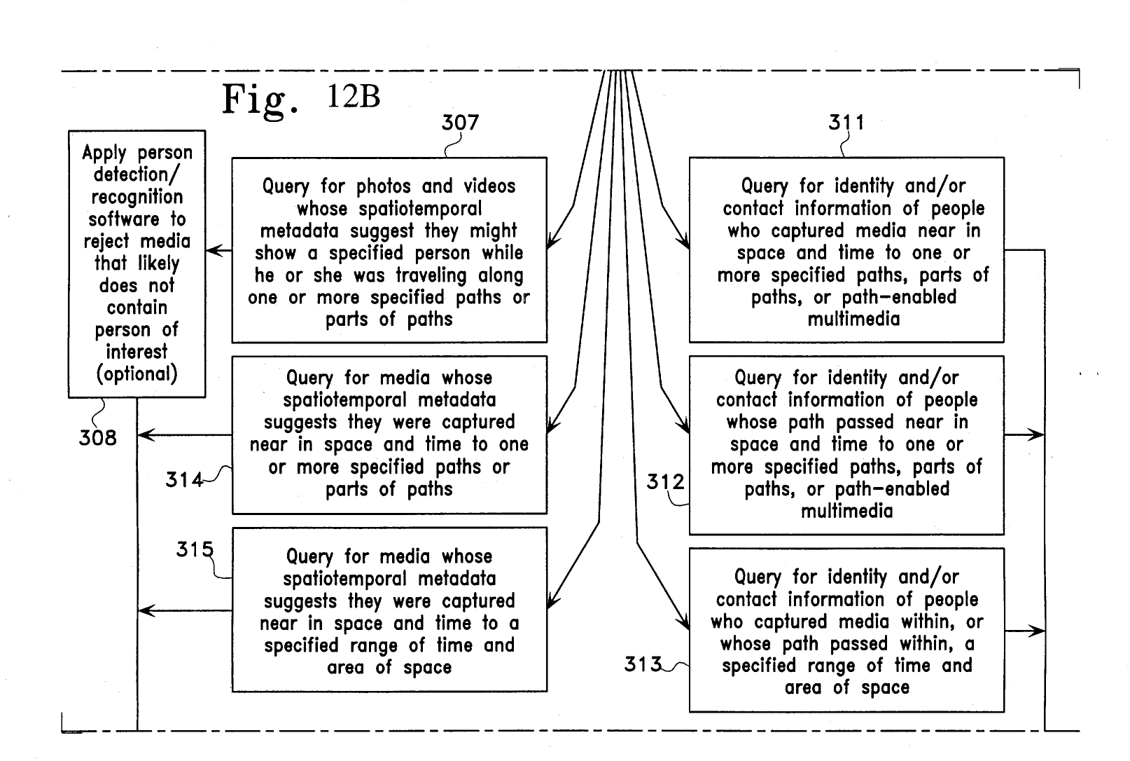

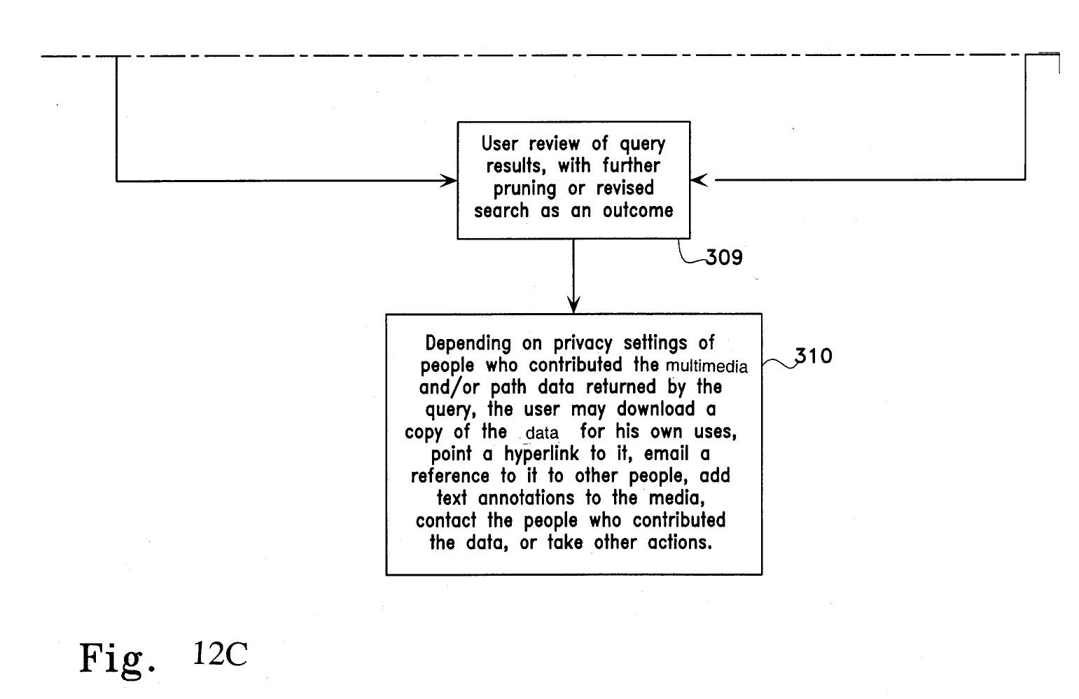

As shown in FIG. 12, the search operations described above can form components of many types of queries and applications supported by path-enhanced multimedia databases. In particular, path data and path-enhanced multimedia captured by the user (Block 301) is contributed (Block 302) to a shared database (Block 303). Other data and path-enhanced multimedia captured by other users (Block 304) are contributed (Block 305) to that same shared database. Privacy control information is either included with the original data, or is subsequently edited (Block 306) to permit limited or full access by other users.

Once this path-oriented data has been downloaded to the shared database, it may be queried by means of the above-described exemplary search operations, for a number of purposes, some of which are illustrated in FIG. 12.

Query Type 1: Find Yourself or Another Individual in Photos and Videos Captured by Others:

Many people have cameras and video recorders, and these devices promise to become more ubiquitous in the future. In some cases, such as at popular tourist destinations or important events, many people are capturing photos and videos at nearly the same place and time. In the case in which several people are carrying devices that capture “path-enhanced” multimedia data, it is possible that a particular person capturing multimedia and/or recording a path may appear in the photos or videos of other people who were capturing multimedia and possibly recording their paths in the area at the time. These photos and videos offer “extra” perspectives of the person and the person's activities. In fact, such photos and videos are likely to be of tremendous interest to this person, as they are to some extent about him, but retain some element of surprise because he likely did not choose when and how to capture them.

If more than one person capturing “path-enhanced” multimedia at roughly the same place and time contribute their PEM data to a common database, the time and location data from one person's path, or the time and location data associated with his captured multimedia, can be used to search for photos and videos captured by other people in the area that may contain imagery of that person (block 307). In one embodiment, this is done by comparing a person's path information with the location and time stamps associated with photos and videos captured by other people. This may be done by applying the path-oriented technique of FIG. 8, using the PEM path, or some portion thereof, captured by the person as the query path S, and requesting all photos and videos in the database near S. If any spatio-temporal coordinate in the path S of the person is sufficiently close in both space and time to that of some photo or video captured by another person, the system may indicate that this photo or video is one in which the person may appear. The user can then review the photo or video to determine whether or not he actually appears in it. This method may be used to search for visual media containing imagery of the person, or a path captured by another user may be selected as the query path, in order to search for imagery containing that person. Furthermore, the person may submit their own captured path, or some portion thereof, as the query path, but search for visual media containing imagery of another person.

Accuracy of the queries may be improved if the PEM database further includes information such as camera orientation, inclination, and field-of-view information stored with the photos and videos data in the PEM data structure. Methods for automatically measuring and storing such information at the time of visual media capture are described in the co-pending patent application entitled “Apparatus and Method for Recording “Path-Enhanced” Multimedia”. When such information is available, candidate photos and videos returned by the database query(because they were taken near some location of the person in space and time) can be excluded if the camera was pointed in the wrong direction (away from the person of interest).

As indicated in Block 308, accuracy may also be improved through use of methods that automatically analyze video and/or images for people, faces, or selected faces. A wide variety of algorithms for automatic person and/or face detection and/or recognition are known in the fields of computer vision and video analysis, and these algorithms often rely on facial features or other pattern detectors in the case of photos, or on analysis of motion dynamics or speech features in the case of videos. If these algorithms are used to search for a particular person or face, the user can supply example photos or video containing the person or face, so that the algorithm(s) may be trained on the person or face to be searched for. Such methods may be employed to exclude query results that appear to not contain people, faces, or a particular person or face of interest. Alternatively, such methods may be used to rank returned visual media according to their likelihood of containing people, faces, or the particular person or face of interest, with the most likely candidates being presented for review to the user first.

When the PEM database is queried to find photos and videos of a specific individual, the query may be limited to find these photos captured within a certain window of time, within some geographical area, while the individual was taking one or more particular labeled trips (for which there is captured path and/or media information that is in the database), or any combination of these.

If a photo(s) or video(s) of interest is found, the user may use the search results to refine the search (block 309). Alternatively, if permitted by the contributor, the user may download a copy of the photo or video, or he may simply point a web link to it and save it in a “digital photo album”. He might be able to forward a copy of it, or a hypertext link to it, to friends and relatives via email, or add his own text annotations to the media (block 310). All of these capabilities are allowed depending on the access restrictions established by the system and by the person who originally captured the media of interest.

Query Type 2: Find individuals who were at the same place at the same time as yourself or others:

In general, according to this query technique, many of the techniques described for Query Type 1 may be used, but the output of interest in this case is the contact information and possibly the identity of other people who were capturing path and/or multimedia data at roughly the same time and place as oneself. For such queries, use of multimedia is not necessarily required (i.e., it can be implemented using path data alone if necessary). When a user queries the database for people who were near him while he was on a particular recorded path (block 311), the relevant path information and/or multimedia time and location stamps are compared with those of other people in the database. All individuals having path and/or multimedia data that are sufficiently close in space and time to those of the user, and that do not wish their identity to remain anonymous for the specified time and location, are returned as search results. These individuals can also be ranked by how closely they passed to the user, how long they remained in close proximity, how many times they passed closely to the person, and so forth, where the definition of “close” is determined by thresholds in space and time.

Query Types 1 and 2 may be implemented in large part via the point-oriented and path-oriented search operations described above and illustrated in FIG. 7 and FIG. 8. For example, the user may select a point in space and time from some path he has taken, a portion of some path, or multiple such path points or portions of a path, and then search for Pathintervals in the database that pass near these selected coordinates. The full PEMs associated with these Pathintervals may be obtained from the Pathinterval data structures, and the identities, contact information, and possibly other data about the individuals who captured those PEMs may be extracted from their respective Headers, in accordance with any privacy restrictions that may be in place. The user might also want to find people passing near a path taken by some other person in the database, in which case an appropriate query can be constructed from points or portions taken from a path captured by someone other than the user.

Query Type 3: Find Individuals who were at a Particular Place and Time, or Range thereof:

This type of query is similar to the search of block 311 (Query Type 2) for the identity, contact information, or other “personal information” pertaining to people who were capturing path and/or multimedia data, except that the search criterion is based not on a recorded path, but on a user specified range of places and times of interest (block 313) or a portion of a user specified spatio-temporal path (block 312) that possibly was never traveled by the user. This class of queries might be useful in automatically constructing mailing lists of individuals who attended a meeting or other event, in finding out who might have taken a picture of or was a witness to some event of interest, in measuring the trends in flow of people through some particular area (such as a retail store), and in many other applications.

Note that these queries may be performed entirely in the absence of multimedia information. In other words, they may be applied even if the database contains no multimedia information; also, even if the database contains multimedia data, they may return information related to people who did not capture any multimedia data. The queries make use of the first and second search operations, but examine the returned Pathintervals only for information about the capturers of the PEMs. These queries may also be performed on databases that contain no path information, and instead store only multimedia with location and time labels, by comparing the places and times of interest with the multimedia labels. However, because the density of sampling of path information is usually higher than the rate at which people capture multimedia, one can expect the results returned by “personal-information” queries performed on such databases to be inferior in quality to similar queries performed on databases of path and/or path-enhanced multimedia data.

The above-described Query Types 2 and 3 can be used as building blocks for constructing more complex queries. Some examples of more complex queries and their implementations are:

Search for individuals who have passed near the user or some other person or people over some period of time: In this case, apply the second, path-oriented search operation to all paths captured by the people of interest during the time window of interest to obtain the desired information about individuals passing near these paths in space and time, and combine the results of the individual queries into a single result list.

Find individuals who have most frequently passed near the user, or some other person or people, over some period of time: Compile the full list of people who have passed near a person, as described above, and keep track of how often each individual person appears in the result list, and, optionally, how long each person spent in proximity to the people of interest and/or optionally, how closely each person passed to the people of interest. Rank the result list of people by some combination of these measures.

Find individuals who share the most common history of places visited as the user or some other person or people: These query types may be implemented in a manner similar to that for the preceding type of queries, except that the searches disregard temporal information. That is, after compiling the list of paths traveled by the person or people of interest, these paths are submitted with infinite temporal proximity bounds, so that all other paths in the database that pass near in space to these paths are selected, regardless of the times at which the respective paths were traveled. Information about the people who traveled the selected paths is then analyzed to answer the query.

There are many applications for these types of searches. For instance, the user might want to start an e-mail chat with others they casually met while on vacation, but for whom they neglected to obtain contact information at the time. The user might also simply want to try to remember something about their trip, and therefore desire to search for others who might know the answer because they were in the same place at the same time. The user may have recently enjoyed the nightlife at a local bar or party and might want to try to contact others they met there. In business contexts, these types of searches can be used to discover the attendees of a given meeting or presentation at which the user was present. And in general, these searches can be used to remind the user of their activities at a particular date and time, based on others near the user at the time.

Query Type 4: Find Media Related to a Trip you or Someone Else Took, or Related to Media you or Someone else Captured:

This query type is similar to the query type 1 in which a specific person is searched for (block 307), except that the user is not just searching for imagery of a particular person or people. Instead, the user may be looking for photos and other multimedia concerning places, other people, events, and other things that came to the attention of the user while on a trip (block 314), but of which the user may not have captured satisfactory multimedia. For instance, the user may have visited Paris and tried to take a picture of Notre Dame, where a special event was happening that day. Upon later review of the photos, however, the user finds that the picture did not turn out well. The user can then use Query Type 4 to search for other individuals′ photos of Notre Dame at about the same time, to find a better photo. This query is performed by searching for photos close in space and time to the unsatisfactory photos, or for searching for photos and videos captured sufficiently close in space and time to points along a relevant portion of the path traveled by the user while in Paris.

Query Type 5: Look for Media Pertaining to a Particular Place and Time, or Range thereof:

This query type is similar to the Query Type 4 in which other recorded media relating to a specific path is searched for (block 314), except that the user manually enters a range of places and times (block 315) in which the user may or may not have been present. The search results are multimedia captured by people (optionally including the user) at these places and times. The user need not supply any path information as part of the query, although the query may optionally be specified as proximity to some fictional path of interest that the user draws or otherwise specifies. Such queries can be useful for browsing a particular event known to have occurred at some location and time (e.g. for remembrance, or for security/law enforcement), seeing the recent history of some location of interest, searching for pictures of a friend or relative who says they were at a particular place and time, and many other applications.

In one embodiment, when using path coordinate information to build database queries, it may be advantageous to use path interpolation techniques to increase the coordinate sampling density along the path, or to redistribute the coordinate samples along the path, beyond the true sampling recorded while the person was traveling. Methods for increasing path sampling density through interpolation are well-known to those skilled in the art.

Privacy issues

In should be noted that the invention allows any of a wide variety of privacy policies to be adopted for the above described applications. In one embodiment, all contributors to the PEM database can identify which aspects of paths and multimedia are allowed for viewing by others using the database. For instance, contributors can specify access restrictions to their path information, to the viewing of their multimedia, or to the linking of their name or other personal data (e.g. email address or city of residence) to their path information or their media information. Contributors can specify that these restrictions should be enforced equally in relation to all other users of the database, or differently for specified individuals or groups of individuals. Contributors can also specify different access restriction policies for different collections or individual pieces of path or multimedia information. For instance, they may be willing to allow viewing of photos of a trip to the Grand Canyon and to allow others to know their name as the capturer of those photos, but they may choose to remain anonymous in relation to photos they captured of a recent trip to Mardi Gras. For some applications, such as those in legal, criminal, insurance, and defense contexts, the use of authentication methods to ensure the verity of path and multimedia data contributed to the database might be employed.

1: In a database for a collection of recorded multimedia and path information, a database structure including a linked sequence of path segments, wherein:
each said segment is linked to at least one respective geotemporal anchor;
each geotemporal anchor includes an associated time and at least some of said anchors also include an associated location;
all said anchors linked to the same said path segment sequence collectively define a specified path in space traversed over a specified period in time; and
at least some of said anchors are linked to respective instances of the recorded multimedia;
whereby temporal and spatial relationships between the individual multimedia and a path reflecting those relationships may be explicitly derived.

2: The database structure of claim 1 further including other sequences of path segments collectively covering a number of predetermined discrete bounded areas and a number of predetermined discrete time intervals, wherein
each said path is divided into a plurality of path intervals, and
each said path interval is linked to a single said predetermined bounded area and to a different said predetermined time interval,
whereby a search for multimedia in said database may be limited to those path segment sequences having an included path interval linked to a specified bounded area and/or to a specified time interval.

3: A database for managing a collection of multimedia objects, the database being stored on a machine-readable medium and comprising:
path-defining data structures defining spatiotemporal paths and linking multimedia objects in the collection to respective points on the spatiotemporal paths, wherein each spatiotemporal path includes an ordered sequence of associated points at respective spatiotemporal locations on the corresponding spatiotemporal path.

4: The method of claim 3, wherein at least one spatiotemporal path includes at least one point unlinked to a respective multimedia object.

5: The database of claim 3, wherein each spatiotemporal path is formed of a sequence of path segments.

6: The database of claim 5, further comprising at least one segment-defining data structure linking a respective path-defining data structure to at least one anchor data structure.

7: The database of claim 3, wherein each path-defining data structure is associated with at least one anchor data structure specifying a temporal location on a corresponding path.

8: The database of claim 7, wherein at least one anchor data structure specifies a spatial location on the corresponding path.

9: The database of claim 7, wherein at least one anchor data structure is linked to a respective multimedia object in the collection.

10: The database of claim 9, wherein at least one anchor data structure includes sensor data describing a context associated with the respective linked multimedia object.

11: The database of claim 10, wherein at least one anchor data structure includes sensor data describing a field-of-view of a visual sensor.

12: The database of claim 3, wherein at least one path segment is associated with one or more user-specified attributes.

13: The database of claim 3, wherein at least one path-defining data structure includes at least one link to a respective multimedia object in the collection.

14: The database of claim 3, further comprising at least one user-identifier associated with a respective spatiotemporal path.

15: The database of claim 3, further comprising at least one view data structure specifying rendering controls for multimedia objects linked to the spatiotemporal path defined by the associated path-defining data structures.

16: The database of claim 15, wherein at least one view data structure specifies a rendering style for multimedia objects linked to the spatiotemporal path defined by the associated path-defining data structures.

17: The database of claim 15, wherein at least one view data structure specifies rendering restrictions for multimedia objects linked to the spatiotemporal path defined by the associated path-defining data structures.

18: The database of claim 3, further comprising at least one view data structure specifying rendering controls for a spatiotemporal path defined by an associated path-defining data structure.

19: The database of claim 3, further comprising indexing data structures defining respective spatiotemporal subdivisions of a spatiotemporal domain encompassing the path-defining data structures.

20: The database of claim 19, wherein indexing data structures in a set are organized as nodes of a hierarchical tree structure subdividing the spatiotemporal domain.

21: The database of claim 20, wherein the tree structure simultaneously subdivides space and time.

22: The database of claim 20, wherein the tree structure is an octree structure.

23: The database of claim 20, wherein the tree structure subdivides space before subdividing time.

24: The database of claim 20, wherein the tree structure subdivides time before subdividing space.

25: The database of claim 20, wherein indexing data structures in a second set are organized as nodes of a second hierarchical tree structure subdividing the spatiotemporal domain differently than the first hierarchical tree structure.

26: The database of claim 19, wherein at least one of the indexing data structures is linked to a path-defining data structure and an associated specification of spatiotemporal bounds of a contiguous portion of the spatiotemporal path defined by the linked path-defining data structure.

27: The database of claim 26, wherein the specified spatiotemporal bounds are encompassed by the spatiotemporal domain subdivision corresponding to the linked index data structure.

28: The database of claim 26, further comprising path interval data structures linking indexing data structures to path-defining data structures.

29: The database of claim 28, wherein each path interval data structure includes a link to an associated path-defining data structure and a specification of spatiotemporal bounds of a contiguous portion of the spatiotemporal path defined by the associated path-defining data structure.

30: A machine-implemented database method for managing a collection of multimedia objects, comprising:
indexing path-defining data structures defining spatiotemporal paths and linking multimedia objects in the collection to respective points on the spatiotemporal paths, wherein each spatiotemporal path includes an ordered sequence of associated points at respective spatiotemporal locations on the corresponding spatiotemporal path; and
storing the indexed path-defining data structures on a machine-readable medium.

31: The method of claim 30, wherein the path-defining data structures are indexed in space and time by a hierarchical tree structure comprising a set of nodes populating a hierarchical sequence of levels, each node defining a respective spatiotemporal subdivision of a spatiotemporal domain encompassing the path-defining data structures.

32: The method of claim 31, wherein each level in the tree structure subdivides both space and time.

33: The method of claim 31, wherein the sequence of levels subdivides space before subdividing time.

34: The method of claim 31, wherein the sequence of levels subdivides time before subdividing space.

35: The method of claim 31, wherein the hierarchical level sequence is ordered from a root node level containing at least one root node to one or more leaf nodes.

36: The method of claim 35, wherein each node is defined by a respective indexing data structure, each leaf node indexing data structure being linked to a respective path-defining data structure.

37: The method of claim 35, wherein each node is defined by a respective indexing data structure, each leaf node indexing data structure being linked to an associated specification of spatiotemporal bounds of a contiguous portion of the spatiotemporal path defined by the linked path-defining data structure.

38: The method of claim 37, further comprising inserting a given path-defining data structure into the hierarchical tree structure.

39: The method of claim 38, wherein inserting the given path-defining data structure comprises dividing the spatiotemporal path defined by the given path-defining data structure at the spatiotemporal bounds specified by the leaf node indexing data structures to form a set of path intervals, and incorporating the path intervals into respective leaf node indexing data structures corresponding to spatiotemporal domain subdivisions encompassing the path intervals.

40: The method of claim 36, further comprising deleting a given path-defining data structure from the hierarchical tree structure.

41: The method of claim 40, wherein deleting the given path-defining data structure comprises de-linking leaf nodes from the given path-defining data structure.

42: The method of claim 36, further comprising modifying the hierarchical tree structure to reflect a modification of a given path-defining data structure.

43: The method of claim 42, wherein modifying the hierarchical tree structure comprises dividing the spatiotemporal path defined by the given path-defining data structure at spatiotemporal bounds specified by the leaf node indexing data structures to identify a set of path intervals, and modifying at least one of a spatiotemporal path and a multimedia object associated with the given path-defining data structure in accordance with the identified set of path intervals.

44: The method of claim 30, further comprising identifying database items based on spatiotemporal paths defined by the indexed path-defining data structures.

45: The method of claim 44, further comprising identifying database items near a specified point of interest.

46: The method of claim 45, wherein the specified point of interest corresponds to a point in time.

47: The method of claim 45, wherein the specified point of interest corresponds to a point in space.

48: The method of claim 45, wherein the specified point of interest corresponds to a spatiotemporal point.

49: The method of claim 45, wherein identifying database items comprises defining a bounding region about the specified point of interest and traversing contiguous points of spatiotemporal paths intersecting the bounding region.

50: The method of claim 44, further comprising identifying database items near a specified portion of a spatiotemporal path.

51: The method of claim 50, wherein identifying database items comprises defining a boundary region about the specified spatiotemporal path portion and identifying contiguous portions of spatiotemporal paths intersecting the boundary region.

52: The method of claim 50, wherein identifying database items comprises comparing points of the identified contiguous path portions to at least one spatiotemporal constraint.

53: The method of claim 50, wherein identifying database items comprises generating a map storing distances of points to the specified temporal path portion.

54: The method of claim 53, wherein the map additionally stores temporal information for points along the specified spatiotemporal path portion.

55: The method of claim 50, wherein identifying database items comprises identifying database items near the specified spatiotemporal path portion in space.

56: The method of claim 50, wherein identifying database items comprises identifying database items near the specified spatiotemporal path portion in time.

57: The method of claim 50, wherein identifying database items comprises identifying database items near the specified spatiotemporal path portion in space and time.

58: The method of claim 30, further comprising identifying database items based on a specified image of a person.

59: The method of claim 30, further comprising identifying persons near a specified point on a spatiotemporal path defined by an indexed path-defining data structure.

60: The method of claim 30, further comprising selectively granting access to database items based at least in part on access restrictions associated with at least a portion of at least one spatiotemporal path defined by an indexed path-defining data structure.

61: A method using a database system managing a collection of multimedia objects, comprising:
accessing a database containing indexed path-defining data structures defining spatiotemporal paths and linking multimedia objects in the collection to respective points on the spatiotemporal paths, wherein each spatiotemporal path includes an ordered sequence of associated points at respective spatiotemporal locations on the corresponding spatiotemporal path; and
querying the database to identify database items.

62: The method of claim 60, wherein querying the database comprises querying the database to identify database items relating to a specified person.

63: The method of claim 60, wherein querying the database comprises querying the database to identify database items near a specified person in at least one of space or time.

64: The method of claim 60, wherein querying the database comprises querying the database to identify database items near in at least one of space and time to a specified point on a spatiotemporal path defined by an indexed path-defining data structure.

65: The method of claim 60, wherein querying the database comprises querying the database to identify database items relating to a specified spatiotemporal path defined by an indexed path-defining data structure.

66: The method of claim 60, wherein querying the database comprises querying the database to identify database items near a specified geographical location.

67: The method of claim 60, wherein querying the database comprises querying the database to identify a person who passes near in space and time to a specified person in the database.

68: The method of claim 60, wherein querying the database comprises querying the database to identify an image containing a person who passes near a specified point in space and time.
